(19) United States
(12) Patent Application Publication
(10) Pub. No.: US 2007/0041063 A1
(43) Pub. Date: Feb. 22, 2007

(54) IMAGE SENSOR

(75) Inventors: Takashi Kitada, Fukuoka (JP); Masahiro Inoue, Fukuoka (JP); Takahiro Komatsu, Fukuoka (JP); Masakazu Mizusaki, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/464,598

(22) Filed: Aug. 15, 2006

(30) Foreign Application Priority Data
Aug. 18, 2005 (JP) P.2005-237175
Jul. 13, 2006 (JP) P.2006-192334

(51) Int. Cl. H04N 1/46

(52) U.S. Cl. 358/513; 358/482

(57) ABSTRACT

An image sensor 1 includes a glass substrate 10, a plurality of photoelectric converting elements 20 made of an organic material, a plurality of IC chips 30 on which driving circuits made of single crystal silicon are respectively mounted, and wirings 40 which connect the plurality of photoelectric converting elements 20 to the respective driving circuits mounted on the IC chips 30. The plurality of photoelectric converting elements 20 are integrally and seamlessly formed with a predetermined arrangement pitch over a predetermined sensor length. The arrangement pitch of a plurality of detecting means formed on the driving circuits mounted on the IC chips 30 is equal to or less than that of the photoelectric converting elements.

### BACKGROUND

The present invention relates to an image sensor for extracting various kinds of information such as the shape or the image of an object as an electrical signal.

Conventionally, as an image sensor for use in a facsimile or a scanner, a contact type linear sensor which can be miniaturized as a set is used since an optical system includes only a rod lens. Such a contact type linear sensor includes a sensor having the same length as an original and includes a plurality of CMOS sensor chips or CCD sensor chips made of single crystal silicon.

Recently, a technology of using an organic material as a photoelectric converting element used in an image sensor and forming the photoelectric converting element by a simple method is disclosed, for example, see WO99/39372.

However, in the technology, when the contact type linear sensor is configured by arranging the plurality of CMOS sensor chips or CCD sensor chips made of single crystal silicon, in order to obtain a predetermined sensor length while maintaining a predetermined pixel pitch, a plurality of single-crystal-silicon chips corresponding to a length of about 300 mm is required and must be accurately arranged in a straight line in the case of the contact type linear sensor having, for example, a size corresponding to an A3 size.

More particularly, when the pixel pitch is at least 600 dpi (the pixel pitch is about 40 μm), since the photoelectric converting element cannot be formed on the end of the above-described chip, information of a joining portion between the chips cannot be read and thus read quality is poor. This problem cannot be solved when a driving circuit for reading signal charge from the photoelectric converting element is made of the same single crystal silicon.

In order to solve this problem, as disclosed in WO99139372, when the photoelectric converting element using the organic material is formed on the driving circuit made of single crystal silicon, a charging ratio (sensor area/pitch area) is improved with certainty, but the single crystal silicon is required by the same length as the sensor and the plurality of chips must be arranged with high precision. The driving chip made of single crystal silicon and having a length of 300 mm can be configured in principle, but cannot be actually realized in view of the yield or the number of chips.

As disclosed in WO99/39372, when the contact type linear sensor is configured by forming the photoelectric converting element using the organic material on a detecting circuit including a thin-film field-effect transistor (TFT) made of polycrystabine silicon, the problem related to the joining porion between the chips is not caused. However, since the carrier mobility of the polycrystalline silicon is smaller than that of the single crystal silicon by a single digit, the detecting circuit requires a plurality of read outputs using a synchronous operation so as to be adapted to high resolution or high-speed operation.

When a variation in threshold value or mobility is large, a variation in read output is large and thus a high-quality image cannot be obtained.

### SUMMARY

Accordingly, it is an object of the present invention is to provide an image sensor having high quality, high-speed operation and low cost.

Further, it is an object of the present invention is to provide an image sensor capable of seamlessly reading information with a high signal-to-noise (SN) ratio, an excellent linear property and a predetermined arrangement pitch over a predetermined sensor length.

According to the invention, an image sensor includes: a photoelectric converting element having a photoelectric converting layer which is an organic compound layer and interposed between a positive electrode and a negative electrode, the photoelectric converting layer including a plurality of pixels for photoelectrically converting incident light into signal charge; a driving circuit which reads the signal charge of the photoelectric converting element; a substrate on which the photoelectric converting element and the driving circuit are mounted, wherein the driving circuit has a plurality of detecting circuits formed in correspondence with the plurality of pixels of the photoelectric converting element, and wherein an arrangement pitch of the plurality of detecting circuits is smaller than that of the plurality of pixels of the photoelectric converting element.

Since a plurality of photoelectric converting elements and a driving circuit are made of different materials and the arrangement pitch of a plurality of detecting means formed on the driving circuit is equal to or less than that of the plurality of photoelectric converting elements, it is possible to reduce the chip size (IC chip size) of the driving circuit made of inorganic semiconductor to be smaller than a predetermined sensor length and to manufacture the plurality of seamless photoelectric converting elements with a predetermined arrangement pitch over the predetermined sensor length. Thus, it is possible to obtain effects such as high quality, high-speed operation and low cost. Further, according to the present invention, an image sensor includes: a photoelectric converting element having a photoelectric converting layer which is made of an organic compound layer and interposed between a positive electrode and a negative electrode; a driving circuit which reads signal charge of the photoelectric converting element; and a substrate on which the photoelectric converting element and the driving circuit are mounted, wherein the driving circuit includes a detecting circuit for detecting the signal charge generated by the photoelectric converting element, and wherein the detecting circuit holds a potential difference between the positive electrode and the negative electrode of the photoelectric converting element at a predetermined value.

Since seamless photoelectric converting elements in which a predetermined arrangement pitch is obtained over a predetermined sensor length can be obtained, the potential difference between the electrodes of the photoelectric converting element is set to a predetermined value and signal charge is stored in driving circuits, it is possible to obtain an image sensor which is not influenced by the capacitance due to the increase in the length of a wiring and can read information with a high SN ratio and an excellent linear property.

### BRIEF DESCRIPTION OF THE DRAWINGS

FIG. 1 is a view schematically showing the configuration of an image sensor according to Embodiment 1 of the present invention.

FIG. 2 is a cross-sectional view of a photoelectric converting element related to Embodiment 1 of the present invention.

FIG. 3 is a view showing the configurations of the photoelectric converting element and a driving circuit in a pixel of the image sensor according to Embodiment 1 of the present invention.

FIG. 4 is a partial perspective view of the image sensor according to the present embodiment.

FIG. 5 is a view showing an example of mounting an IN chip.

FIG. 6 is a plan view of an image sensor according to Embodiment 2 of the present invention.

FIG. 7 is a circuit diagram showing the configuration of a pixel of the image sensor according to Embodiment 2 of the present invention.

FIG. 8 is a timing chart showing an output signal of the image sensor according to Embodiment 2 of the present invention.

FIG. 9 is a circuit diagram showing the configuration of a pixel of an image sensor according to Embodiment 3 of the present invention.

FIG. 10 is a view showing the configurations of a photoelectric converting element and a driving circuit in an image sensor according to Embodiment 3 of the present invention.

### DESCRIPTION OF THE EMBODIMENTS

Hereinafter, a best mode of the present invention will be described in detail with reference to the accompanying drawings. Like reference numerals in the drawings denote like elements, and thus their description will be omitted. The description herein is made by the best mode of the present invention.

### Embodiment 1

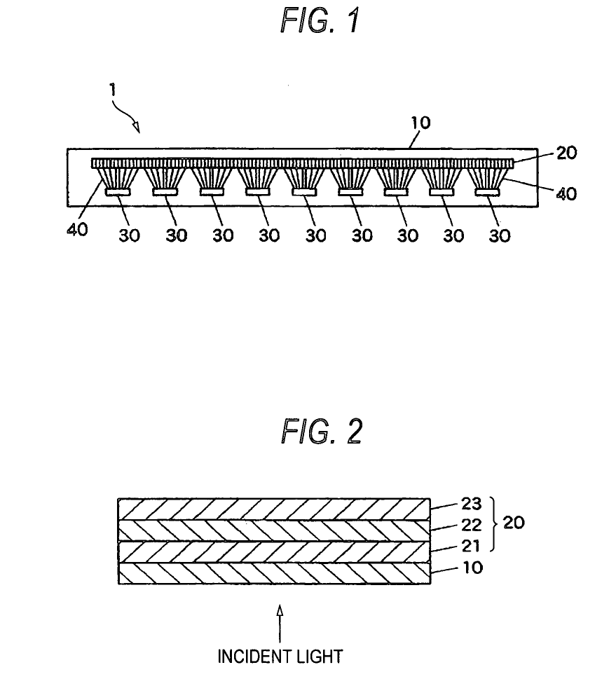

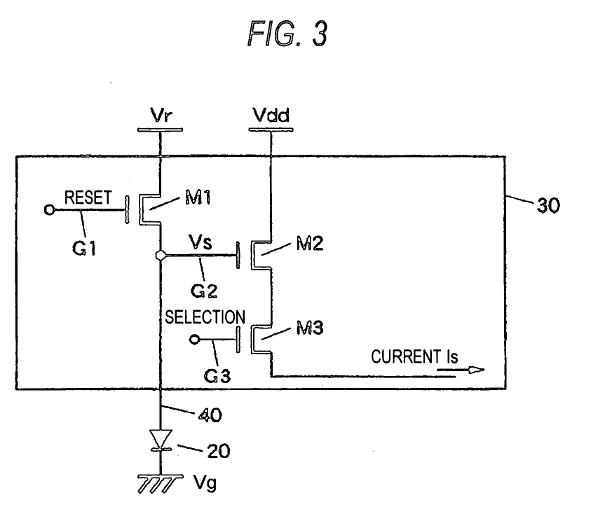

FIG. 1 is a view schematically showing the configuration of an image sensor according to Embodiment 1, FIG. 2 is a cross-sectional view of a photoelectric converting element related to Embodiment 1, and FIG. 3 is a view showing the configurations of a photoelectric converting element and a driving circuit in a pixel of the image sensor according to Embodiment 1.

As shown in FIG. 1, a linear sensor will be described as an image sensor 1.

The image sensor 1 includes a glass substrate 10 as a substrate, photoelectric converting elements (a plurality of photoelectric converting elements) made of an organic material 20, a plurality of IC chips 30 on which driving circuits made of single crystal silicon are mounted, respectively, and wirings 40 for electrically connecting the photoelectric converting elements 20 and the driving circuits mounted on the IC chips 30.

In Embodiment 1, the photoelectric converting elements (the plurality of photoelectric converting elements) 20 are arranged with a predetermined pitch (predetermined arrangement pitch) and a predetermined length. The plurality of IC chips 30 on which the driving circuits made of single crystal silicon are mounted, respectively, have a length smaller than the predetermined length of the photoelectric converting element 20 although all the IC chips 30 are arranged in a row.

Accordingly, the plurality of wirings 40 for connecting the plurality of photoelectric converting clement 20 and the plurality of IC chips 30 are not parallel to one another.

The configuration of the photoelectric converting element 20 will be described.

As shown in FIG. 2, the photoelectric converting element 20 includes an ITO (iridium-tin oxide) positive electrode 21 as a first electrode, an organic photoelectric converting layer 22 which is an organic compound layer including an electron donative layer made of an electron donative material and an electron receiving layer made of an electron receiving material, and an aluminum negative electrode 23 as a second electrode.

Now, a method of manufacturing the photoelectric converting element will be described.

First, an ITO film having a thickness 150 nm was formed on the glass substrate 10 by a sputtering method and a resist material (made by Tokyo Ohka Kogyo Co., Ltd; OFPR-800) was coated on the ITO film by a spin coating method to form a resist film. The resist film was patterned in the shapes of the ITO positive electrode 21 and the wirings by masking, exposure and development.

Thereafter, the glass substrate 10 was immersed in a hydrochloric acid aqueous solution of 18 N at a temperature of 60° C., the ITO film on which the resist film is not formed was etched and cleaned with water, and the resist film was removed, thereby forming the positive electrode (ITO positive electrode 21) and the wiring 40, which are made of the ITO film having a predetermined pattern shape.

Next, the glass substrate 10 was ultrasonic-cleaned using a cleaning material (made by Furuuchi Chemical Corporation; Semicoclean) for five minutes, was ultrasonic-cleaned using pure water for ten minutes, was ultrasonic-cleaned using a solution mixed in ammonia water (volume ratio) by a ratio of water to hydrogen peroxide solution of 1:5 and was ultrasonic-cleaned using pure water having a temperature of 70° C. for five minutes in sequence. Moisture attached to the glass substrate 10 was removed by a nitrogen blower and the glass substrate 10 was heated and dried at a temperature of 250° C.

Subsequently, poly(3,4)ethylenedioxithiophene/polystyrenesulfonate (PEDT/PSS) dropped on the glass substrate 10, on which the ITO positive electrode 21 was formed, through a 0.45-μm filter using a spin coating method and was uniformly coated. The glass substrate 10 was heated in a clean oven having a temperature of 200° C. for ten minutes to form a charge transport layer having a thickness of 60 nm.

The glass substrate 10 on which the charge transport layer is formed was introduced into a resistance heating deposition apparatus and molybdenum oxide was deposited in the resistance heating deposition apparatus in a state where pressure is reduced until a vacuum degree becomes equal to or less 0.27 mPa (=2×10⁻⁶Torr) to form a buffer layer having a thickness of 5 nm.

A chlorohenzene solution including poly(2-methoxi-5(2′-ethylhexyloxy)-1,4-phenylenevinylene) (hereinafter, referred to as MEH-PPV) which functions as an electron donative organic material and [5,6]-phenyl C61 butyric acid methyl ester (hereinafter, referred to as [5,6]-PCBM) which functions the an electron receiving material with a weight ratio of 1:4 was spin-coated on the glass substrate 10 having the buffer layer and was heated in a clean oven having a temperature of 100° C. for 30 minutes, thereby forming an organic photoelectric converting layer 22 having a thickness of about 100 nm.

MEH-PPV is a P-type semiconductor and [5,6]-PCBM is an N-type organic semiconductor. An electron which is an exciter generated by light absorption diffuses in a conduction band and donates to [5,6]-PCBM and a hole diffuses in a balance band and donates to MEH-PPV. The electron and the hole are transmitted to the aluminum negative electrode 23 and the ITO positive electrode 21 through MEH-PPV and [5,6]-PCBM respectively.

Since [5,6]-PCBM can be mixed with MEH-PPV which is modified fulerene, has a high electron mobility, and is the electron donative material, it is possible to separately carry an electron-hole pair (a pair of electron and hole). Accordingly, it is possible to increase the photoelectric efficiency of the organic photoelectric converting layer 22 and to manufacture the photoelectric converting element 20, that is, the image sensor 1, with low cost.

Finally, lithium fluoride (LiF) was formed on the organic photoelectric converting layer 22 with a thickness of about 1 nn in the resistance heating deposition apparatus in which the pressure is reduced until the vacuum degree becomes equal to or less than 0.27 mPa (=2×10⁻⁶Torr) and aluminum was formed with a thickness of about 10 nm, thereby forming the aluminum negative electrode 23. It is possible to seamlessly and cheaply manufacture the photoelectric converting element having a predetermined sensor length and predetermined resolution on the glass substrate 10. Next, the operation of the image sensor 1 will be described with reference to FIG. 3. As shown in FIG. 3, incident light is photoelectrically converted into signal charge and the signal charge is stored in the photoelectric converting element 20 made of an organic material.

The potential Vs of the stored signal charge is applied to the gate G2 of an amplifying transistor (detecting means) M2 through the wiring 40. The amplifying transistor (detecting means) M2 detects the output of the signal charge based on the potential Vs applied to the gate G2.

The signal (signal charge) is read by reading current Is flowing through a switching transistor (reading means) M3 by the control of a selection signal input to the gate G3 of the switching transistor (reading means) M3. That is, when the selection signal for reading the signal charge from a corresponding photoelectric converting element is input to the gate G3 of the switching transistor M3, the switching transistor M3 is turned on and thus the current Is is read.

The sensor potential Vs is reset to a reset voltage Vr by the control of a reset signal input to the gate G1 of a reset transistor M1 and the reset transistor M1. A sensor storage time is determined by the reset operation.

The timings of the read operation of the signal charge and the reset operation of the sensor potential Vs are controlled by a shift register (not shown).

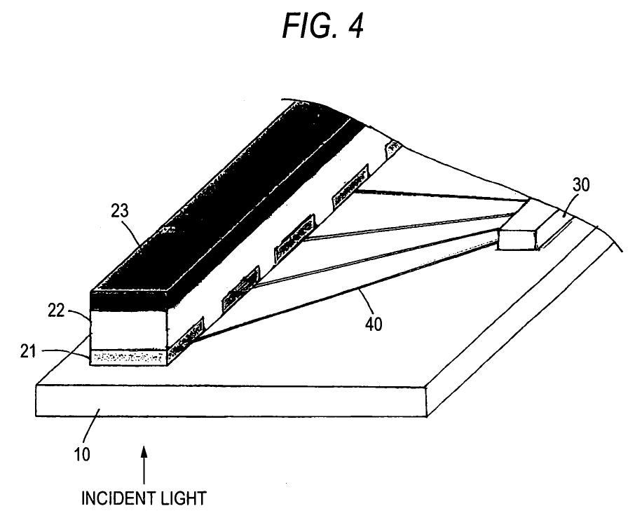

FIG. 4 is a partial perspective view of the image sensor according to the present embodiment.

As shown in FIG. 4, the photoelectric converting element 20 and the input terminals of the driving circuits in the IC chips 30 are connected to each other by the wirings 40 in one-to-one correspondence.

For example, the driving circuit (detecting circuit) of a pixel of the amplifying image sensor configured above is mounted by the existing 0.35-μm CMOS process such that the arrangement pitch of the detecting circuits per one pixel can is equal to or less than 40 μm (pixel pitch is 600 dpi).

Accordingly, when a contact type image sensor (amplifying image sensor having resolution of 600 dpi is configured, the arrangement pitch of the detecting circuits can be sufficiently smaller than that of the pixels of the photoelectric converting elements 20 made of the organic material.

When the arrangement pitch of the detecting circuits is smaller than that of the pixels of the photoelectric converting elements 20 and the photoelectric converting elements and the driving circuits are integrally configured by the same process like the prior art, the length of the single crystal silicon which is determined by the arrangement pitch of the photoelectric converting elements and the sensor length of the image sensor can very shorten.

In view of the yield or the number of the detecting circuits, it is possible to very cheaply manufacture the contact type image sensor compared with the conventional image sensor. Since the driving circuit is made of the single crystal silicon, the carrier mobility is sufficiently large and thus a high-speed operation is possible.

Although a configuration in which the detecting circuits are arranged in a row is described in the present embodiment, the detecting circuits are arranged in a plurality of rows such that a width-direction length thereof increases but a longitudinal-direction length thereof decreases, in view of the yield or the number of detecting circuits

Next, the mounting of the driving circuit in the IC chip 30 will be described.

In the case of 600 dpi corresponding to the A3 size, about 7500 pixels are required. Accordingly, 30 single-crystal-silicon chips each including 250 inputs are arranged, and may be mounted by a method of attaching a metal bump to a bare chip IC and thermocompression-bonding the bare chip IC to the glass substrate using ACF instead of wire connection.

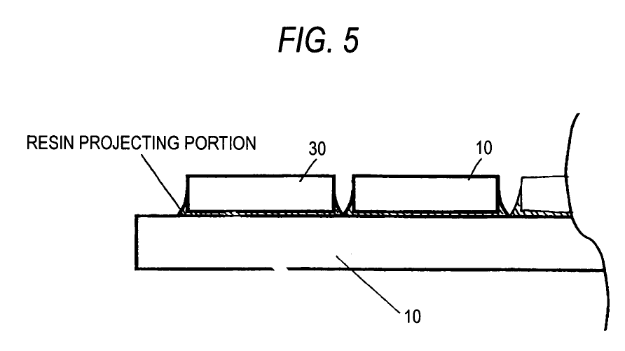

When the IC chip 30 is thermocompression-bonded using the ACF, a resin portion of the ACF is projected as shown in FIG. 5 and is hardened such that a resin projecting portion is formed between the IC chips 30.

Accordingly, when the driving circuits are arranged with the same pitch as the arrangement pitch of the pixels of the photoelectric converting element 20, the plurality of IC chips 30 cannot be arranged on the glass substrate 10 parallel to the photoelectric converting elements 20 due to the existence of the resin projecting portions between the IC chips 30 and thus the mounting reliability is reduced.

In the present embodiment, since the arrangement pitch of the detecting circuits is smaller than that of the pixels of the photoelectric converting elements 20, it is possible to ensure the pitch of the IC chips 30. Since the resin projecting portion is formed, it is possible to improve the mounting reliability.

The driving circuit is divided in plural (the plurality of driving circuits are configured), but the photoelectric converting elements 20 are seamlessly formed of the organic material as described above. Accordingly, the conventional problem that information between the chips (CMOS sensor chips or CCD sensor chips) cannot be read is not caused.

It is possible to seamlessly manufacture the photoelectric converting elements 20 having a predetermined sensor length and predetermined resolution by a cheap manufacturing process.

Since the driving circuit for detecting and reading the signal charge from the photoelectric converting element 20 is formed of the single crystal silicon, the driving circuit can be manufactured in a chip size equal to or less than the predetermined sensor length.

Accordingly, it is possible to cheaply realize an image sensor which can operate at a high speed.

In the present embodiment, with respect to a method of manufacturing the photoelectric converting element (hereinafter, referred to as an organic photoelectric converting element) 20 made of the organic material, any method may be used if a thin film having uniformity and smoothness can be stably formed. For example, a variety of vacuum processes such as a vacuum deposition method or a sputtering method or a wet process such as a spin coating method, a dipping method or an inkjet method may be used as the manufacturing method.

However, among these methods, any method may be selected in view of a used material or the configuration, but, in order to accomplish the low cost which is one of the characteristics of the organic photoelectric convening element, it is preferable that an organic layer is formed by the wet process which does not require a large-scale manufacturing apparatus.

Although a case where the image sensor applies to the linear sensor is described in the present embodiment, the present invention is not limited thereto and may apply to an area sensor In this case, the read of the signal may be of an X-Y address type using two switching transistors.

Although the glass (glass substrate 10) is used as the substrate in the present embodiment, the present invention is not limited thereto and any substrate may be used if the substrate can support the first electrode (for example, the ITO positive electrode), the organic photoelectric converting layer and the second electrode (for example, the aluminum negative electrode).

As the substrate, various high molecular materials such as polyethyleneterephtalate, polycarbonate, polymethylmetacrylate, polyeter sulfone, polyfluorovinyl, polypropylene, polyvethylene, polacrylate, amorphous polyolefin or fluorinated resin or various metallic materials a silicon wafer may be used.

In the present embodiment, as the electron donative material which is the material configuring the organic photoelectric converting layer (organic compound layer) 22, a copolymer of a polymer having phenylenevinylene and a derivative thereof, fluorene and a derivative thereof, fluorene-based copolymer (POF66, P1 F66 or PFPV) having a quinoline group or a pyridine group in a framework, arylamine polymer containing fluorene, carbazole and a derivative thereof, indole and a derivative thereof, pyrene and a derivative thereof, pyrrole and a derivative, picoline and a derivative thereof, thiophene and a derivative thereof, acetylene and a derivative thereof, a diacetylene and a derivative thereof as a recurring unit and the other monomer or a high molecular material of a group called dendrimer is used.

The electron donative material is not limited to the high molecular material. For example, a porphin compound such as porphin, tetraphenyl porphin copper, phtalcyanine, copper phtalcyanine or titanium phtalcyanine oxide, aromatic tertiary amine such as 1,1-bis {4-di-P-tolylamino } phenyl} cyclohexane, 4,4′,4″-trimethyltriphenylarnine, N,N,N′,N′-tetrakis(P-tolyl)-P-phenylenediamine, 1-(N,N-di-P-tolylamino)naphthalene, 4,4′-bis(dimethylamino)-2-2′-dimethyltriphenylmethane, N,N,N′,N′-tetraphenyl-4,4′-diaminobiphenyl or a stilbene compound such as N-phenylcarbazol, a stilbene compound such as 4-di-tolylaminostilbene or 4-(di-P-tolylamino)-4′-[4-(di-P -tolylamino)styryl]stilbene, triazole and a derivative thereof, oxadiazole and a derivative thereof, imidazole and a derivative thereof, polyarylalkane and a derivative thereof, pyrazoline and a derivative thereof, pyrazolone and a derivative, phenylenediamine and a derivative thereof, anylamine and a derivative thereof, amino-substituted chalkone and a derivative thereof, oxyazole and a derivative thereof, styryl-anthracene and a derivative thereof, fluorenone and a derivative thereof, hydrazone and a derivative thereof, silazane and a derivative thereof, polysilane-based aniline-based copolymer, high molecular oligomer, a styrylamine compound, an aromatic dimethylidine-based compound or poly-3-methylthiophene may be used.

As the electron receiving material which is the material configuring the organic photoelectric converting layer (organic compound layer) 22, oxadiazole such as 1,3-bis(4-tert-buthylphenyl-1,3,4-oxadiazolyl)phenylene(OXD-7) and a derivative thereof, anthraquinonedimethane and a derivative thereof, diphenylquinone and a derivative thereof, fullerene and a derivative thereof, or, more particularly, PCBM (6,6)-phenyl C61 butyric acid methyl ester) carbon nano tube and a derivative thereof is used.

As a transparent electrode used as the first electrode formed below the organic photoelectric converting layer 22 (at the side of the substrate), ITO (indium-tin oxide), ATO (SnO₂ doped with Sb) or AZO (ZnO doped with Al) is used. Since the transparent electrode is formed of the same light transmission material as the metal thin film such as Al, Ag or Au, the transparent electrode may have light transmission properties. Accordingly, it is possible to provide a light receiving portion having light transmission properties.

As the second electrode formed on the organic photoelectric converting layer 22, a metal material such as Al, Ag or Au is generally used. As the second electrode, a thin film formed of metal such as Al, Ag, Au, Cr, Cu, In, Mg, Ni, Si or Ti, an Mg alloy such as an Mg—Ag alloy or an Mg—In alloy, or an Al alloy such as an Al—Li alloy, an Al—Sr alloy or an Al—Ba alloy is used. In order to improve short-circuit current, a method of inserting a thin film formed of metal oxide or metal fluoride between the organic layer and the negative electrode is preferably used. Alternatively, ITO, ATO or AZO may be used.

In the present embodiment, as needed, the configuration of the photoelectric converting element using a high molecular material such as PEDOT:PSS (a mixture of polythiophene and polystyrene sulfonic acid between the first electrode or the second electrode and the organic photoelectric converting layer as a buffer layer or the configuration of the photoelectric converting element using an inorganic material such as silicon, titania, alumina, carbon or zirconia as a block layer of leakage current is suitably used.

As needed, the configuration of the photoelectric converting element using metal fluoride or oxide such as lithium fluoride (LiF) between the organic photoelectric converting layer and the second electrode or a third electrode formed thereon as a buffer layer is suitably used.

As described above, according to the present embodiment, since the photoelectric converting elements (the plurality of photoelectric converting elements) 20 are made of the organic material which can be manufactured by a cheap manufacturing process, the driving circuits are made of single crystal silicon and the arrangement pitch of the detecting means of the driving circuits is smaller than that of the plurality of photoelectric converting elements, it is possible to realize seamless photoelectric converting elements (the plurality of photoelectric converting elements) having a predetermined arrangement pitch over a predetermined sensor length and cheap driving circuits which can operate at a high speed.

Accordingly, it is possible to accomplish a predetermined arrangement pitch over a predetermined sensor length and to realize a cheap image sensor which can operate at a high speed.

In the present embodiment, it is possible to provide an image sensor having a high signal-to-noise (SN) ratio or an excellent linear property by the same driving circuit as those described in Embodiments 2 to 4.

The image sensor according to the present embodiment is applicable to an input device such as a scanner or a facsimile.

### Embodiment 2

Since a general contact type image sensor receives diffision light from an original, the amount of incident light is very small and photoelectrically converted current is hard to be directly detected. Thus, the generated current must be stored for a predetermined time and be current-to-voltage converted. Accordingly, the organic photoelectric converting element requires a photoelectric converting function and a storage function. In order to include the storage function (to prevent dark current), an insulating material such as carbon must be inserted between an positive electrode and a negative electrode, but, in this case, photoelectric converting efficiency may deteriorate by the influence of the inserted insulating material or the amount of incident light may be reduced by the influence of the insulating material. When the current is stored in the photoelectric converting element, a bias voltage is applied to the photoelectric converting element according to the storage amount. Thus, the converting efficiency of the photoelectric converting element is not uniform and thus the linear property of the photoelectrically converted current value and the incident light is poor.

A driving circuit for detecting and reading signal charge from the photoelectric converting element is generally formed of a silicon transistor and the manufacturing process thereof is different from that of the photoelectric converting element.

Accordingly, the driving circuit is spaced apart from the photoelectric converting element by a predetermined distance, the distance of a wiring connected therebetween lengthens, the capacitance thereof increases, the amount of the signal charge from the photoelectric converting element decreases, and the signal charge cannot be accurately detected. More particularly, when the resolution of the photoelectric converting element is at least 600 dpi, the capacitance of the photoelectric converting element is very small and thus the change in capacitance due to the difference between the wiring distances cannot be ignored.

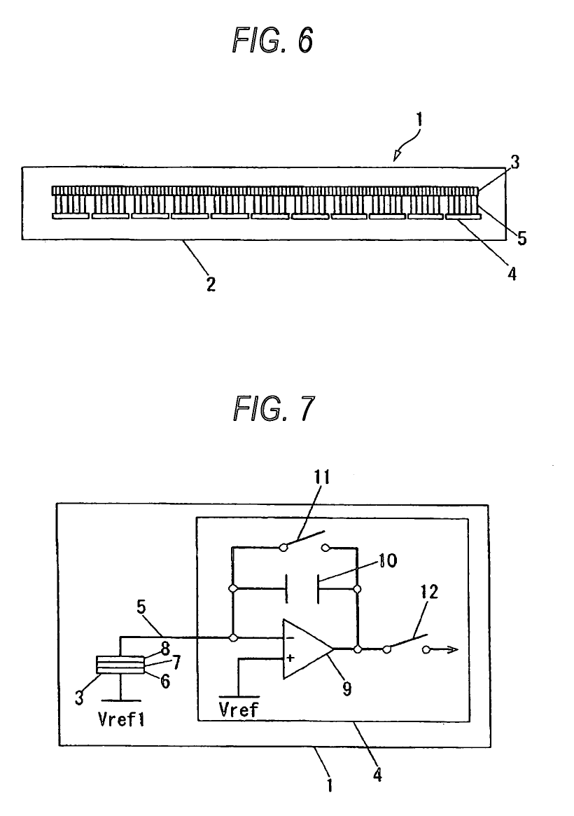

FIG. 6 is a plan view of an image sensor according to Embodiment 2 of the present invention. In FIG. 6, a reference numeral 1 denotes the image sensor according to Embodiment 2 of the present invention, 2 denotes a glass substrate as a substrate of the image sensor 1, 3 denotes a photoelectric converting element of the image sensor 1 made of an organic material, 4 denotes an integrated circuit (IC) chip on which a driving circuit made of single crystal silicon is mounted, and 5 denotes a wiring for connecting the photoelectric converting element 3 and the IC chip 4. Although not shown, the IC chip 4 includes detecting means for detecting signal charge generated by the photoelectric converting element 3 and signal charge reading means for reading the signal charge detected by the detecting means.

Although a plurality of wirings 5 for connecting the pixels of the photoelectric converting elements 3 with the driving circuits of the IC chips 4 are substantially formed in parallel in the present embodiment, the configuration shown in FIG. 1 related to Embodiment 1 may be used.

The configuration and the manufacturing process of the photoelectric converting element 3 are equal to those of Embodiment 1 and thus their description will be omitted.

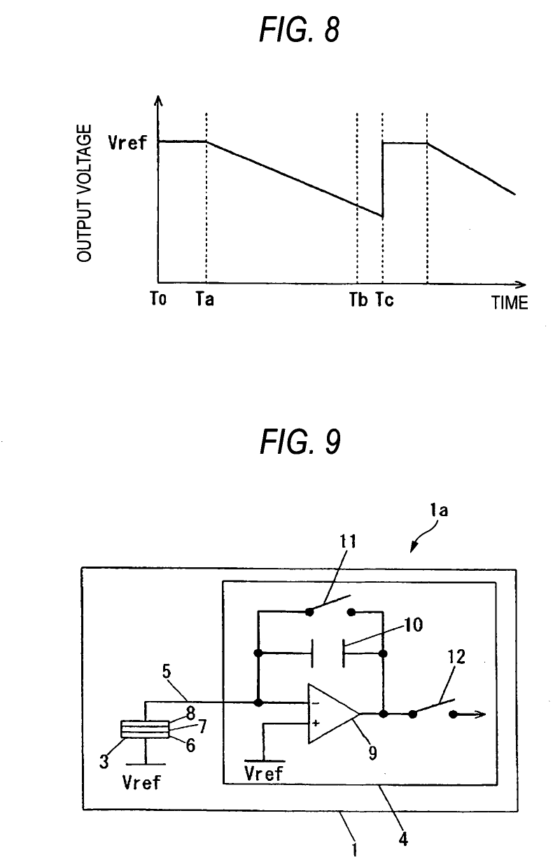

The operation of the image sensor configured above will be described with reference to FIGS. 7 and 8. FIG. 7 is a circuit diagram showing the configuration of a pixel of the image sensor according to Embodiment 2 of the present invention and FIG. 8 is a timing chart showing the output signal of the image sensor according to Embodiment 2 of the present invention. In FIG. 7, a reference numeral 9 denotes an operational amplifier, 10 denotes a storage capacitor, 11 denotes a reset switch for resetting charge stored in the storage capacitor 10, and 12 denotes a reading switch for reading a storage voltage value. The storage capacitor 10 is interposed between an inversion input terminal of the operational amplifier 9 and an output terminal to configure an integration circuit. The potential of an aluminum negative electrode 8 of the photoelectric converting element 3 is a level Vref1 and the potential of a non-inversion input terminal of the operational amplifier 9 is a level Vref(Vref1>Vref). In FIG. 3, only the detecting means of the driving circuit mounted on the IC chip 4 is shown. The signal charge reading means can use a conventionally known circuit and thus their description will be omitted.

In a time period 0 to Ta of the timing chart shown in FIG. 8, a reset switch 11 is controlled to be turned on to reset the storage capacitor 10. At this time, the output voltage of the operational amplifier 9 becomes the level Vref.

Subsequently, the reset switch 11 is controlled to be turned off at a time Ta. At this time, when incident light enters the photoelectric converting element 3 formed of an organic material, the incident light is photoelectrically converted into photoelectric current and the photoelectric current flows into the IC chip 4 on which the driving circuit is mounted through the ITO positive electrode 6 and the wiring 5. In the IC chip 4, the photoelectric current is fed back through the storage capacitor 10 such that the potential difference between two input terminals becomes 0 by the operation of the operational amplifier 9 and is stored in the storage capacitor 10. Accordingly, the output level of the operational amplifier 9 is changed from the level Vref depending on the capacitance of the storage capacitor 10 and the amount of the photoelectric current.

Thereafter, when the time reaches a predetermnined time, the reading switch 12 is controlled such that the output of the operational amplifier 9 is sequentially read by the signal charge reading means of the IC chip 4 (time period Tb to Tc). The resetting, storing and reading operations are repeated to obtain the information of the pixels.

As described above, since the aluminum negative electrode 8 of the photoelectric converting element 3 is connected to the level Vref1 and the ITO positive electrode 6 is controlled to become the level Vref by the operation of the operational amplifier 9, the both electrodes of the photoelectric converting element 3 becomes a reverse bias state having a predetermined potential difference. Accordingly, although the wiring capacitance increases by the wiring 5 for connecting the photoelectric converting element 3 and the IC chip 4, the ITO positive electrode 6 of the photoelectric converting element 3, the wiring 5 and the inversion input terminal of the operational amplifier 9 are always held at the same potential. As a result, since the photoelectric current is stored in the storage capacitor 10 of the IC chip 4 without loss due to the wiring capacitance, the signal level is not reduced. At this time, since the photoelectric current photoelectrically converted by the photoelectric converting element 3 is accelerated by a reverse bias voltage applied to the photoelectric converting element 3, extracting efficiency is improved and sensitivity is improved. Since the potential difference (bias voltage) between the both electrodes of the photoelectric converting element 3 is always held at the predetermined level, the converting efficiency of the photoelectric converting element is a predetermined value and the linear property of the photoelectric current value for the incident light amount is improved.

Although the present invention applies to the linear sensor in Embodiment 2, the image sensor according to the present invention is not limited to the linear sensor and may apply to an area sensor. In this case, the read of the signal may be of an X-Y address type using two switching transistors.

Although the photoelectric converting element 3 is formed on the glass substrate 2, the IC chip 4 is chip-on-glass (COG) mounted and the photoelectric converting element 3 and the IC chip 4 are connected by the wiring 5 in Embodiment 2, the present invention may apply to an image sensor in which the photoelectric converting element 3 is formed on the electrode of the IC chip 4. In this case, the plurality of IC chips 4 must be arranged with high precision. However, since the wiring area does not exist on the glass substrate 2, the influence of external noise is reduced.

Although means for separating color is not described in Embodiment 2, a color filter may be used as means for separating colors of R (Red), G (Green) and B (Blue) or the spectral property of an organic material may be used instead of the color filter.

According to the image sensor of Embodiment 2 of the present invention, since the potential of the aluminum negative electrode 8 of the photoelectric converting element 3 becomes the level Vref1 and the potential of the ITO positive electrode 6 becomes the level Vref lower than the level Vref1 by the operation of the operational amplifier 9, a reverse bias voltage having a predetermined value is applied between the both electrodes of the photoelectric converting element 3. Accordingly, it is possible to efficiently extract the photoelectric current which is the signal component generated by the incident light.

The wiring capacitance increases by the wiring 5 for connecting the photoelectric converting element 3 and the IC chip 4, but the ITO positive electrode 6 of the photoelectric converting element 3, the wiring 5 and the inversion input terminal of the operational amplifier 9 are always held at the same potential. Accordingly, the photoelectric current is stored in the storage capacitor 10 of the IC chip 4 without loss due to the wiring capacitance. Thus, the signal level is not reduced.

Since the potential difference (bias voltage) between the both electrodes of the photoelectric converting element 3 is always held at a predetermined level, the converting efficiency of the photoelectric converting element 3 becomes a predetermined value.

By the above operation, it is possible to provide an image sensor capable of seamlessly reading information with a high SN ratio, an excellent linear property for incident light amount and a predetermined arrangement pitch over a predetermined sensor length.

Since the IC chip 4 on which the driving circuit is mounted is formed of the single crystal silicon transistor, mobility is high, a high-speed operation is possible, a variation in threshold value is small, the capability uniformity is excellent, and quality variation in individual and between individuals is reduced. As a result, it is possible to provide an image sensor having excellent reliability and practicality

### Embodiment 3

FIG. 9 is a circuit diagram showing the configuration of a pixel of an image sensor according to Embodiment 3 of the present invention. The configuration of FIG. 9 is similar to that of FIG. 7 related to Embodiment 2 and thus their description will be omitted.

An image sensor 1a according to Embodiment 3 is different from Embodiment 2 in that the potential of the aluminum negative electrode of the photoelectric converting element 3 is connected to the same level Vref as the non-inversion terminal of the operational amplifier 9 as shown in FIG. 9.

By this configuration, the potential of the ITO positive electrode 6 of the photoelectric converting element 3 also becomes the level Vref by the operation of the operational amplifier 9. As a result, the potential difference between the both electrodes of the photoelectric converting element 3 substantially becomes 0. Accordingly, it is possible to reduce dark current which is a noise component of photoelectric current generated by incident light. At this time, since a reverse bias voltage is not applied between the both electrodes of the photoelectric converting element 3, the extracting efficiency due to the bias voltage is not obtained like Embodiment 2, but the reduction of the dark current increases and, as a result, the SN ratio can be improved.

According to the image sensor of Embodiment 3, in addition to the effect of Embodiment 2, since the voltage applied to the both electrodes of the photoelectric converting layer is 0, it is possible to decrease the dark current which is the noise component and to shorten the time for detecting and storing the signal charge with high SN ratio.

### Embodiment 4

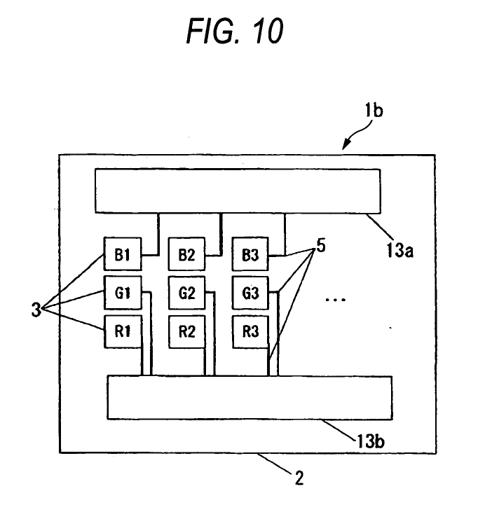

FIG. 10 is a view showing the configurations of a photoelectric converting element and a driving circuit in an image sensor according to Embodiment 4 of the present invention. In FIG. 10, a reference numeral 3 denotes a multi-color photoelectric converting element in which pixels for dispersing and absorbing red light (R), green light (G) and blue light (B) are arranged in a row and 13a and 13b denote driving circuits. In FIG. 10, the driving circuit 13a is the driving circuit of a pixel for photoelectrically converting blue light and the driving circuit 13b is the driving circuit of a pixel for photoelectrically converting red light. The same components as FIG. 7 related to Embodiment 2 are denoted by the same reference numerals and their description will be omitted.

The image sensor 1b according to Embodiment 4 is different from Embodiment 2 in that the driving circuits 13a and 13b are formed by integrally forming thin film transistors made of polycrystalline silicon or amorphous silicon on the glass substrate 2.

According to this configuration, since the IC chip 4 on which the driving circuits made of single crystal silicon need not be bare-mounted like Embodiment 2, it is possible to cheaply produce the image sensor 1b with high reliability

Since the driving circuits can be formed in the vicinity of the photoelectric converting element 3 and the driving circuits 13a and 13b are provided at the both sides of the photoelectric converting element 3, it is possible to shorten the wirings of the driving circuits 13a and 13b and the photoelectric converting element 3. As a result, it is possible to reduce the influence of external noise.

According to the image sensor of Embodiment 4, in addition to the effect of Embodiment 2, since the silicon transistor configuring the driving circuit is formed of the thin film transistor made of polycrystalline silicon or amorphous silicon, the IC chip need not be mounted on the glass substrate and thus an image sensor having low cost and excellent productivity can be obtained. Since the driving circuits 13a and 13b are formed of the thin film transistors, it is possible to decrease the length of the wirings 5 for connecting the driving circuits 13a and 13b and the photoelectric converting element 3 and to reduce the external noise. As a result, the signal charge can be detected with a high SN ratio and the storing time can be reduced.

The present invention is applicable to an image sensor used in a scanner or a facsimile for extracting various kinds of information such as the shape or the image of an object as an electrical signal.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

This application is based upon and claims the benefit of priorities of Japanese Patent Application No. 2005-237175 filed on Aug. 18, 2005 and Japanese Patent Application No. 2006-192334 filed on Jul. 13, 2006, the contents of which are incorporated herein by reference in its entirety.

What is claimed is:

1. An image sensor comprising:
a photoelectric converting element having a photoelectric converting layer which is an organic compound layer and interposed between a positive electrode and a negative electrode, the photoelectric converting layer including a plurality of pixels for photoelectrically converting incident light into signal charge;
a driving circuit which reads the signal charge of the photoelectric converting element;
a substrate on which the photoelectric converting element and the driving circuit are mounted,
wherein the driving circuit has a plurality of detecting circuits formed in correspondence with the plurality of pixels of the photoelectric converting element, and
wherein an arrangement pitch of the plurality of detecting circuits is smaller than that of the plurality of pixels of the photoelectric converting element.

2. The image sensor according to claim 1, wherein the driving circuit is formed of inorganic semiconductor.

3. The image sensor according to claim 2, wherein the driving circuit is a silicon transistor.

4. The image sensor according to claim 3, wherein the silicon transistor is formed of single crystal silicon.

5. The image sensor according to claim 1, wherein the driving circuit is formed in plural.

6. The image sensor according to claim 1, wherein the photoelectric converting element includes the plurality of pixels which are seamlessly and integrally formed.

7. The image sensor according to claim 1, wherein the plurality of pixels of the photoelectric converting element are linearly arranged on the substrate and the plurality of detecting circuits of the driving circuit are linearly arranged on the substrate substantially in parallel to the plurality of pixels.

8. An image sensor comprising:
a photoelectric converting element having a photoelectric converting layer which is made of an organic compound layer and interposed between a positive electrode and a negative electrode;
a driving circuit which reads signal charge of the photoelectric converting element; and
a substrate on which the photoelectric converting element and the driving circuit are mounted,
wherein the driving circuit includes a detecting circuit for detecting the signal charge generated by the photoelectric converting element, and
wherein the detecting circuit holds a potential difference between the positive electrode and the negative electrode of the photoelectric converting element at a predetermined value.

9. The image sensor according to claim 8, wherein the detecting circuit holds the potential difference between the positive electrode and the negative electrode at 0V.

10. The image sensor according to claim 8, wherein the driving circuit includes a single crystal silicon transistor.

11. The image sensor according to claim 8, wherein the driving circuit includes a thin film transistor which is made of polycrystalline silicon or amorphous silicon and formed on the substrate.

12. An image sensor comprising:
a photoelectric converting element having a photoelectric converting layer which is an organic compound layer and interposed between a positive electrode and a negative electrode, the photoelectric converting layer including a plurality of pixels for photoelectrically converting incident light into signal charge;
a driving circuit which reads the signal charge of the photoelectric converting element; and
a substrate on which the photoelectric converting element and the driving circuit are mounted,
wherein the driving circuit has a plurality of detecting circuits formed in correspondence with the plurality of pixels of the photoelectric converting element,
wherein each of the detecting circuits holds a potential difference between the positive electrode and the negative electrode of the pixel corresponding thereto at a predetermined value, and wherein an arrangement pitch of the plurality of detecting circuits is smaller than that of the plurality of pixels of the photoelectric converting element.
